(19) United States
(12) Patent Application Publication
(10) Pub. No.: US 2015/0372519 A1
(43) Pub. Date: Dec. 24, 2015

(54) CHARGING AND DISCHARGING DEVICE

(71) Applicant: DENSO CORPORATION, Kariya-city (JP)

(72) Inventors: Taiji ABE, Nukata-gun (JP); Hiroomi FUNAKOSHI, Chiryu-city (JP)

(21) Appl. No.: 14/741,749

(22) Filed: Jun. 17, 2015

(30) Foreign Application Priority Data
Jun. 18, 2014 (JP) 2014-125469

(51) Int. Cl. H02J 7/00

(52) U.S. Cl. CPC H02J 7/0052

(57) ABSTRACT

A charging and discharging device is capable of connecting a power storage device and a normal charging device, which supplies AC power. The power storage device includes a DC inlet, a storage part and a storage control part. An AC inlet of the charging and discharging device is detachably connectable to a normal charging connector of the normal charging device. A DC connector is detachably connectable to the DC inlet. A converting part converts AC power supplied from the normal charging device through the AC inlet to DC power. A charging and discharging control part controls power conversion in the converting part. By connecting the power storage device and the normal charging device through the charging and discharging device, power supply and reception between the power storage device and the normal charging device can be enabled and the configuration of the power storage device is simplified.

### CROSS REFERENCE TO RELATED APPLICATION

The present application is based on Japanese patent application No. 2014-125469 filed on Jun. 18, 2014, the content of which is incorporated herein by reference.

### FIELD

The present disclosure relates to a charging and discharging device, which is employed to connect an electric power storage device and an AC power device.

### BACKGROUND

Two charging methods are conventional for an electric vehicle. One is a normal charging method, which performs charging in a relatively long time period with AC power supplied from a commercial home electric power outlet or the like. The other is a rapid charging method, which charges in a relatively short time period by converting AC power to high-voltage DC power. For example, a charging device for a vehicle according to JP 2012-191754 A is provided with a rapid charging device and a rapid charging connector as well as a normal charging device and a normal charging connector so that normal charging or rapid charging may be performed.

However, since the charging device for a vehicle is provided with both configurations related to rapid charging and normal charging, mounting it on a vehicle increases a total weight of the vehicle. Further, since two connectors need be provided, more limitations are imposed on designing a vehicle.

### SUMMARY

It is therefore an object to provide a charging and discharging device, which has a simple configuration related to charging and discharging of a power storage device.

According to one aspect, a charging and discharging device is provided to be capable of connecting an AC power part for supplying or receiving AC power and a power storage device, which includes a storage-side connector part provided to be detachably connectable to a connector part of a DC charging device for supplying DC power, a storage part chargeable with the DC power supplied through the storage-side connector part and a storage control part for controlling a charging and discharging state of the storage part. The charging and discharging device comprises an AC connector part detachably connectable to a connector part of the AC power part, a DC connector part detachably connectable to the storage-side connector part, a converting part, and a charging and discharging control part for controlling power conversion in the converting part. The converting part performs at least one of a conversion of the AC power, which is supplied from the AC power part through the AC connector part, to the DC power, and a conversion of the DC power, which is supplied from the storage part through the DC connector part, to the AC power.

### BRIEF DESCRIPION OF THE DRAWINGS

FIG. 1 is a block diagram showing a configuration of a charging and discharging device according to a first embodiment;

FIG. 2A, FIG. 2B and FIG. 2C are schematic circuit diagrams showing an operation of a switching part in the first embodiment;

FIG. 3 is a flowchart showing charging starting processing in the first embodiment;

FIG. 4 is a block diagram showing a configuration of a charging and discharging device according to a second embodiment;

FIG. 5 is a flowchart showing charging starting processing in the second embodiment;

FIG. 6 is a flowchart showing charging starting processing in a third embodiment;

FIG. 7 is a flowchart showing charging starting processing in a fourth embodiment;

FIG. 8 is a block diagram showing a configuration of a charging and discharging device according to a fifth embodiment;

FIG. 9 is a flowchart showing charging starting processing in the fifth embodiment;

FIG. 10 is a block diagram showing a configuration of a charging and discharging device according to a sixth embodiment;

FIG. 11 is a flowchart showing charging starting processing in the sixth embodiment; and

FIG. 12 is a block diagram showing a configuration of a charging and discharging device according to a seventh embodiment.

### EMBODIMENT

A charging and discharging device will be described below with reference to plural embodiments shown in the accompanying drawings. In the plural embodiments, substantially same configurations are denoted with same reference numerals for simplification of description.

### First Embodiment

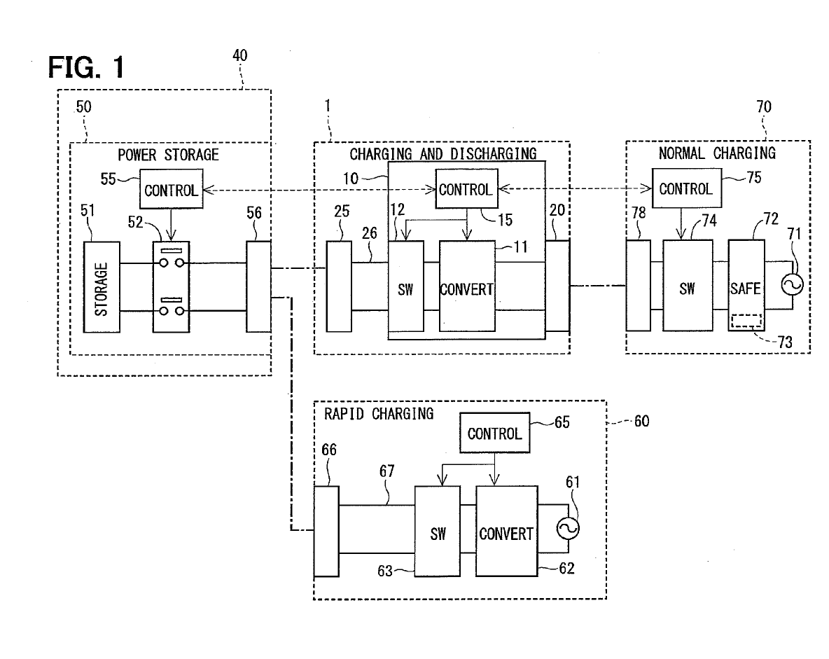

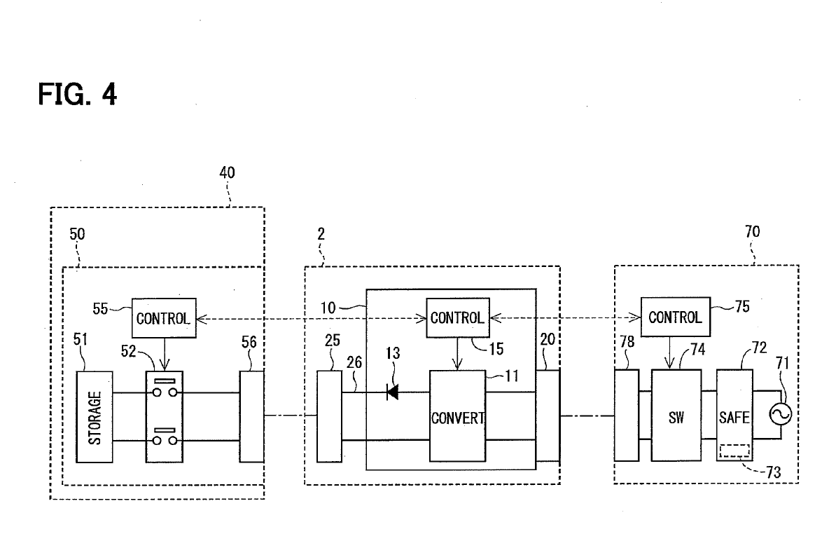

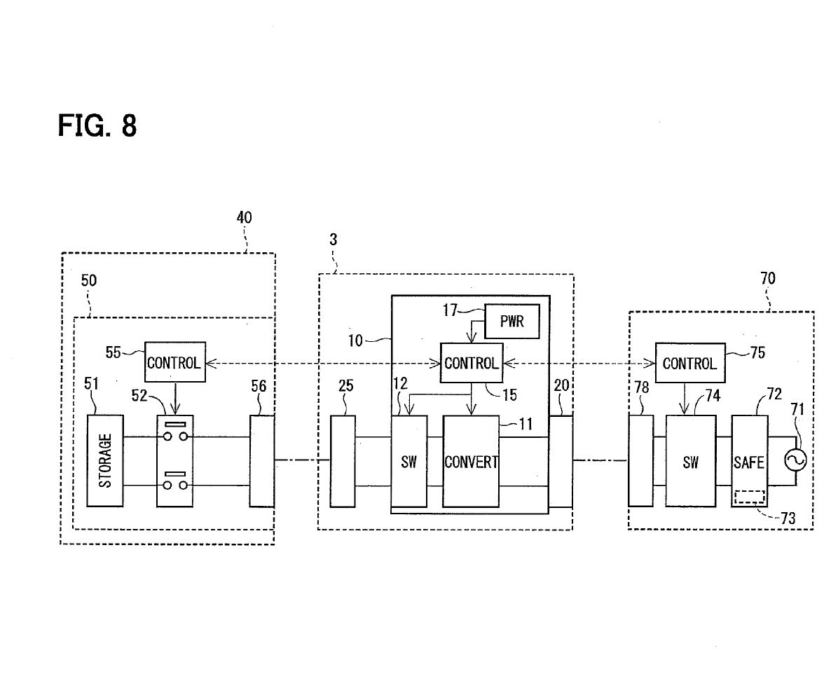

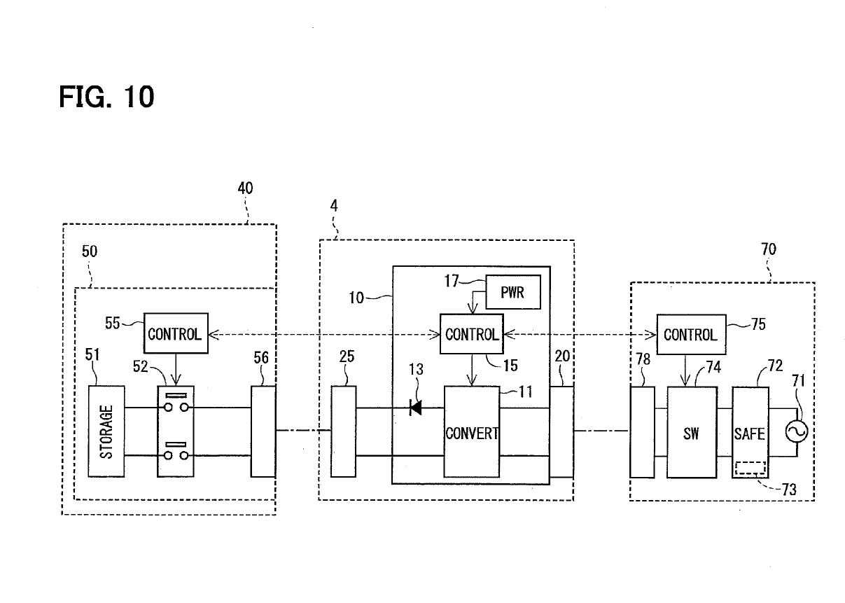

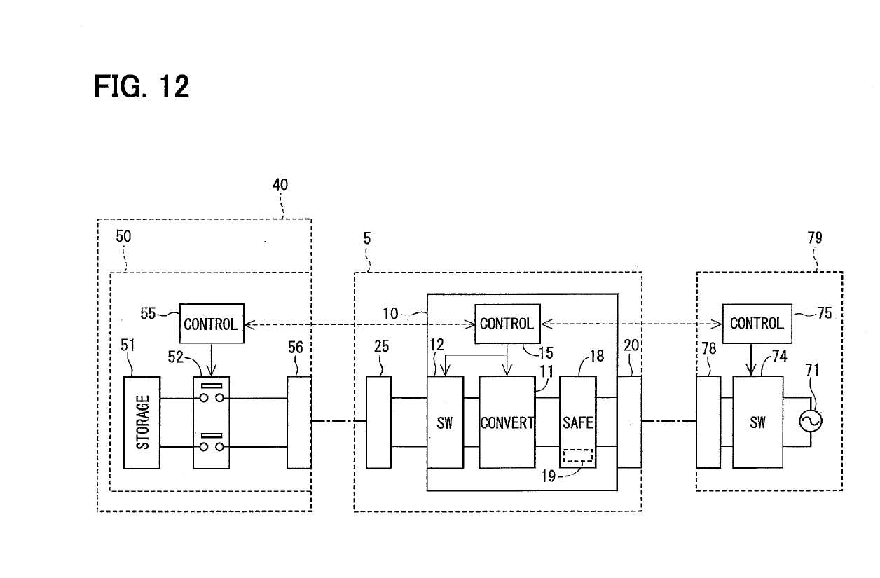

A charging and discharging device according to a first embodiment is shown in FIG. 1 to FIG. 3. In FIG. 1, control lines are indicated with solid-line arrows and communication lines capable of transmitting and receiving information are indicated with broken-line arrows. Communication may be performed by wired circuits or radio circuits. One-dot chain lines indicate structural parts which can be attached and detached. The explanations described above also apply to FIG. 4, FIG. 8, FIG. 10 and FIG. 12 described below.

Referring to FIG. 1, a charging and discharging device 1 is provided to connect a power storage device 50, which is mounted on a vehicle 40, with a normal charging device 70, which is an AC power part. The vehicle 40 is an electric vehicle or a plug-in hybrid vehicle (PHV).

The power storage device 50, a rapid charging device 60, which is a DC charging device, and the normal charging device 70 will be described first. The power storage device 50 is formed of a storage part 51, a storage switching part 52, a storage control part 55 and a DC inlet, which is a storage-side connector part, and the like. The storage part 51 may be a secondary battery, an electric double layer capacitor or the like, which is capable of charging and discharging, for example. The secondary battery may be a nickel-metal hydride type or a lithium-ion type. The storage part 51 is configured to be chargeable with DC power supplied through a DC inlet 56, which is a storage-side connector part. Power of the storage part 51 is supplied to drive a main motor (not shown) and the like provided in the vehicle 40.

The storage switching part 52 is provided between the storage part 51 and the DC inlet 56 to conduct or shut off a current, which flows between the storage part 51 and the DC inlet 56. The storage switching part 52 is configured as normally-open type switches, which are provided in a low-potential power line and a high-potential power line, respectively. The storage control part 55 executes various control processing in the power storage device 50 such as switching control for the storage switching part 52 thereby to control a charging and discharging state of the storage part 51. The DC inlet 56 is configured to be detachable from a rapid charging connector 66 of the rapid charging device 60.

The rapid charging device 60 is formed of an AC power supply source 61, a rapid charging converting part 62, a rapid charging switching part 63, a rapid charging control part 65, a rapid charging connector 66 and the like. The AC power supply source 61 supplies AC power of three-phase 200 [V], for example.

The rapid charging converting part 62 converts the AC power of the AC power supply source 61 to DC power to produce a DC voltage, which can be supplied to the power storage device 50. In the rapid charging converting part 62, the AC power is converted to high-voltage DC power of about 500 [V], for example. This high-voltage DC power is supplied to the power storage device 50 thereby to charge the storage part 51 in a short period of time.

The rapid charging switching part 63 is provided between the rapid charging converting part 62 and the rapid charging connector 66 to conduct or shut off a current, which flows between the rapid charging converting part 62 and the rapid charging connector 66. Similarly to the storage switching part 52, the rapid charging switching part 63 is configured as normally-open type switches, which are provided in a low-potential power line and a high-potential power line, respectively.

The rapid charging control part 65 executes various control processing in the rapid charging device 60 such as an operation of the rapid charging converting part 62 and switching control for the rapid charging switching part 63. The rapid charging control part 65 is configured to be capable of communication with the storage control part 55. In FIG. 1, communication lines between the storage control part 55 and the rapid charging control part 65 are not shown.

The rapid charging connector 66 is connected to the rapid charging switching part 63 and also to the rapid charging converting part 62 through the cable 67. The rapid charging connector 66 is configured to be detachable from the DC inlet 56 of the power storage device 50. With the connection of the rapid charging connector 66 to the DC inlet 56, the DC power produced from the rapid charging converting part 62 is supplied to the power storage device 50. Thus the storage part 51 of the power storage device 50 is chargeable by the rapid charging device 60. The rapid charging connector 66 is a connector part of a DC charging device.

The normal charging device 70 is formed of an AC power supply source 71, an electrical safety part 72, a normal charging switching part 74, a normal charging control part 75, a normal charging connector 78 and the like. The AC power supply source 71 supplies AC power of a single-phase 100 [V] or 200 [V], for example. The electrical safety part 72 is a charging circuit interrupting device (CCID), for example, which includes a shut-off part 73. The electrical safety part 72 detects an abnormality such as a short-circuit by monitoring a power state. The electrical safety part 72 interrupts power supply from the AC power supply source 71 by driving the shut-off part 73 into a power shut-off state when the abnormality is detected.

The normal charging switching part 74 is provided between the AC power supply source 71 and the connector 78 to conduct or shut off a current, which flows between the AC power supply source 71 and the connector 78. Similarly to the storage switching part 52, the normal charging switching part 74 is configured as normally-open type switches, which are provided in a low-potential power line and a high-potential power line, respectively.

The normal charging control part 75 executes various control processing in the normal charging device 70 such as switching control for the normal charging switching part 74. The connector 78 is configured to be detachable from an AC inlet 20 described below. The connector 78 is configured to be incapable of connection to the DC inlet 56 of the power storage device 50. The connector 78 is a connector part of an AC power part.

A rapid charging operation of the rapid charging device 60 and a normal charging operation of the normal charging device 70 will be described here. The storage part 51 of the power storage device 50 is configured to be capable of being charged in a relatively shorter time period than charging by the normal charging device 70 when it is charged with the high-voltage DC power supplied from the rapid charging device 60. It is not desirable to continue only the rapid charging from the standpoint of life of the storage part 51. For this reason, it is more desirable to perform the normal charging by the normal charging device 70 at a predetermined interval thereby to mitigate burden on the storage part 51. However, in a case that a charging system including the normal charging device 70 is mounted on the vehicle 40 in addition to a charging system including the rapid charging device 60, the entire charging system on the vehicle 40 becomes complicated and increases vehicle weight. Further, since two inlets need be provided, more limitations are imposed on a vehicle designing work.

The normal charging device 70 needs a relatively long time period to charge the storage part 51. It is therefore preferred from the standpoint of convenience of a user to perform the rapid charging at a visiting place, which is outside a home of a driver of the vehicle 40. If the vehicle 40 mounted with the power storage device 50 is a PHV vehicle, fuel such as gasoline may be used to drive and hence the normal charging, which needs long charging time period, is not meritorious at the visiting place.

For the reasons described above, the vehicle 40 is not provided with a configuration (for example, AC inlet), which directly connects to the connector 78 of the normal charging device 70. Instead, the power storage device 50 and the normal charging device 70 are connectable through the charging and discharging device 1 thereby to enable charging of the storage part 51 with the normal charging device 70. The charging and discharging device 1 is a portable type, which are detachable from the power storage device 50 and the normal charging device 70, and configured to be capable of being carried upon request by a user. That is, it may be carried when a user plans to charge the storage part 51 by the normal charging device 70 at the visiting place and need not be carried when the user does not plan to charge the storage part 51 at the visiting place.

The charging and discharging device 1 will be described in more detail below assuming that it is used to operate as a charging device, which charges the storage part 51 by supplying the power from the normal charging device 70 to the power storage device 50. The charging and discharging device 1 is formed of a converting part 11, a switching part 12, a charging and discharging control part 15, an AC inlet 20 as an alternating current connector part, a DC connector 25 as a direct current connector part, and the like. The converting part 11 is a converter and the switching part 12 is switches. The converting part 11, the switching part 12 and the charging and discharging control part 15 are housed in a casing 10 to be hand-carried. The converting part 11 includes an AC/DC converting part, which converts the AC power supplied from the normal charging device 70 to the DC power, and a DC/DC converting part, which converts the DC power produced by the AC/DC converting part to the voltage suitable to be supplied to the power storage device 50. In a case that the DC power produced by the AC/DC converting part is suitable to be supplied to the power storage device 50, the DC/DC converting part need not be provided.

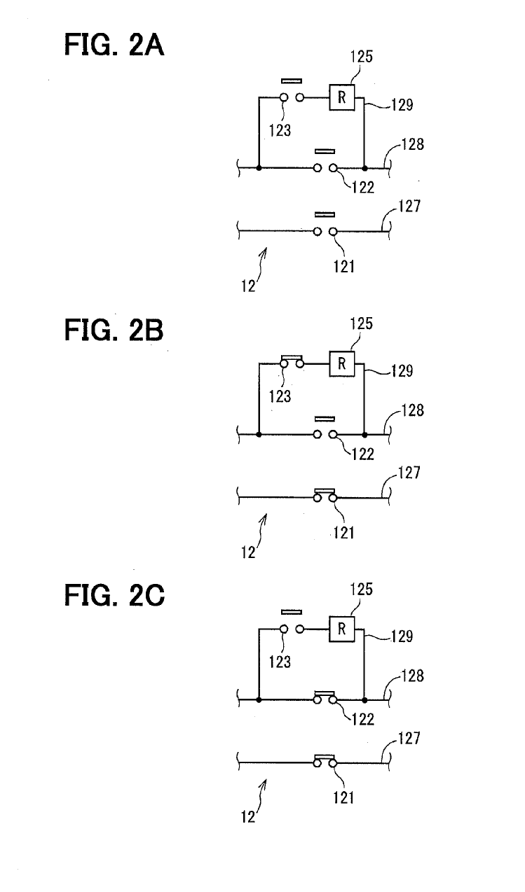

The switching part 12 is provided between the converting part 11 and the connector 25 to conduct or shut off a current, which flows between the converting part 11 and the connector 25. As shown in FIG. 2A, FIG. 2B and FIG. 2C, the switching part 12 includes a first switch 121, a second switch 122, a third switch 123 and a resistor 125. As shown in FIG. 2A, the first switch 121, the second switch 122 and the third switch 123 are all normally-open type switches and controlled to turn on and off by the charging and discharging control part 15.

The first switch 121 is provided in a low-potential power line 127. The second switch 122 is provided in a high-potential power line 128. The third switch 123 is connected in a bypass power line 129, which is in the high-potential power line 128, and provided in a manner to bypass the second switch 122. The resistor 125 is provided in the bypass power line 129. The resistor 125 is provided to be closer to the converting part 11 than the third switch 123 is.

As shown in FIG. 2B, before starting charging of the storage part 51, the first switch 121 and the third switch 123 are turned on and the second switch 122 are turned off thereby to perform a pre-charging operation, that is, to perform charging with a relatively low current. As shown in FIG. 2C, in charging the storage part 51 (charging operation), the first switch 121 and the second switch 122 are turned on and the third switch 123 are turned off thereby to perform a charging operation with a relatively high current.

Referring to FIG. 1 again, the charging and discharging control part 15 executes various processing of the charging and discharging device 1, which includes power conversion of the converting part 11, switching operation control for the switching part 12 and the like.

The charging and discharging control part 15 is configured to be capable of transmitting and receiving information through communication with the storage control part 55 and the normal charging control part 75. The communication method may be, for example, communication using controller area network (CAN), control pilot line transmission (CPLT) or homeplug green PHY (HPGP: HomePlug is a trademark), in correspondence to the storage control part 55 and the normal charging control part 75.

The AC inlet 20 is provided on the casing 10 and configured to be capable of being attached to and detached from the normal charging connector 78 of the normal charging device 70. The connector 25 is provided at a top end of the cable 26, which is taken out of the casing 10, and configured to be capable of being attached to and detached from the DC inlet 56 of the power storage device 50. Thus the charging and discharging device 1 is detachably connected to both of the power storage device 50 and the normal charging device 70.

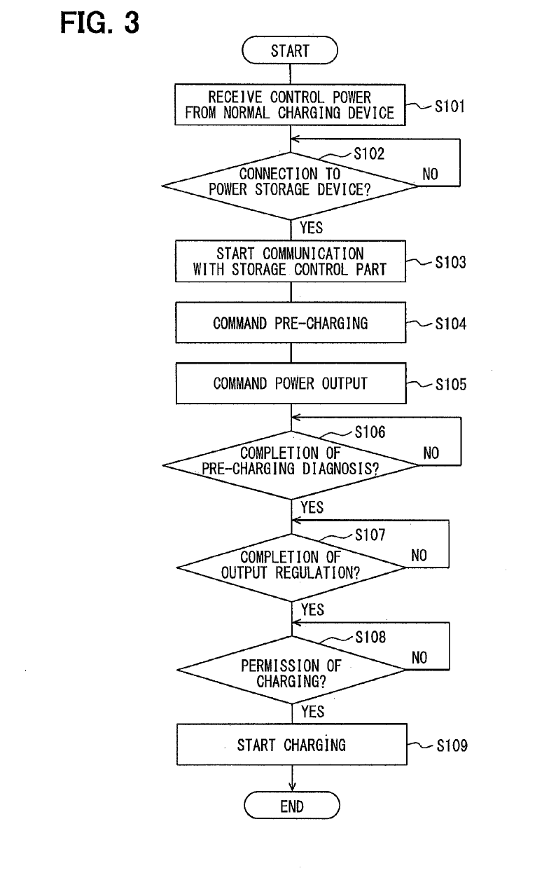

The charging starting processing in the charging and discharging control part 15 will be described with reference to a flowchart shown in FIG. 3. For this processing, the charging and discharging control part 15 is configured with a programmed computer, which includes a memory for storing control programs and a processor for executing the stored program. The charging starting processing is executed by the charging and discharging control part 15 after the AC inlet 20 of the charging and discharging device 1 and the connector 78 of the normal charging device 70 is attached and power supply from the normal charging device 70 to the charging and discharging device 1 is permitted.

At first step S101 (step is indicated simply as S below), power required for the operation of the charging and discharging device 1 is received from the normal charging device 70 and used as control power. The power required for the operation of the charging and discharging device 1 is a power, which is used for operations of the converting part 11 and the switching part 12 as well as calculation and communication of the charging and discharging control part 15. At S102, it is checked whether the connector 25 of the charging and discharging device 1 and the vehicle 40 side, that is, the DC inlet 56 of the power storage device 50, are connected and the connection to the power storage device 50 is detected. When it is determined that the connection to the vehicle 40 side is not detected (S102: NO), this checking step is repeated. When it is determined that the connection to the vehicle 40 side is detected (S102: YES), s103 is executed.

At S103, communication with the storage control part 55 is started to communicate required information with the storage control part 55 before starting the charging operation. At S104, pre-charging is commanded. Specifically, commands for turning on the first switch 121 and the third switch 123 are issued to control the switching part 12 to a state shown in FIG. 2B.

At S105, a command for outputting power is commanded to the converting part 11 and a pre-charging diagnosis is executed. At S106, it is checked whether the pre-charging diagnosis has been completed. When it is determined that the pre-charging diagnosis has not yet been completed (S106: NO), this checking step S106 is repeated. When it is determined that the pre-charging diagnosis has been completed (S106: YES), S107 is executed on condition that no abnormality is found. When any abnormality is detected as a result of the pre-charging diagnosis, subsequent steps are not executed so that no charging is performed. At S107, output power of the converting part 11 is regulated and it is checked whether output power regulation has been completed. When it is determined that the output power regulation has not yet been completed (S107: NO), the output power regulation is continued. When it is determined that the output power regulation has been completed (S107: YES), S108 is executed.

At S108, it is checked whether a signal, which permits charging to the storage part 51, has been received from the storage control part 55. When it is determined that the signal indicating a permission of charging has not yet been received (S108; NO), this checking step 5108 is repeated. When it is determined that the signal indicating the permission of charging has been received (S108: YES), S109 is executed.

At S109, DC power supply from the normal charging device 70 to the power storage device 50 is started to charge the storage part 51. Specifically, commands for turning on the first switch 121 and the second switch 122 are issued to control the switching part 12 to a state shown in FIG. 2C so that charging the storage part 51 with the power from the normal charging device 70 is started. After the charging is completed, the charging is stopped after executing charging completing processing.

The power storage device 50 is configured to be capable of being charged with the power supplied directly from the rapid charging device 60, which supplies the DC power, and not configured to be charged with the power supplied directly from the normal charging device 70, which supplies the AC power. Thus, the power storage device 50 can be configured to be light-weighted and small-sized.

The charging and discharging device 1 is configured to include the converting part 11 and the like for charging the power storage device 50 with the power supplied from the normal charging device 70. By using the charging and discharging device 1, the storage part 51 of the power storage device 50 can be charged with the power supplied from the normal charging device 70. Thus, by using the charging and discharging device 1, the storage part 51 can be charged with the power supplied from the normal charging device 70 in addition to charging with the power supplied from the rapid charging device 60. By using both the rapid charging and the normal charging, loading of the storage part 51 can be reduced. Further, in the case that charging by the normal charging device 70 at the visiting place is not planned, the weight of the vehicle can be reduced by not carrying the charging and discharging device 1. In a case that charging by the normal charging device 70 at the visiting place is planned, the charging and discharging device 1 should be carried but this is not inconvenient because of its portability.

The normal charging device 70 includes the electrical safety part 72. Thus, since the charging and discharging device 1 does not need electrical safety function, structural parts for the electrical safety function are not provided. As a result, the charging and discharging device 1 can be simplified. In a case that the normal charging device 70 does not have any structural parts for the electrical safing function, it is desired to connect the normal charging device 70 and the charging and discharging device 1 through an electrical safety device, which is provided separately.

As described above in detail, the charging and discharging device 1 is capable of connecting the power storage device 50 and the normal charging device 70, which supplies AC power. The power storage device 50 includes the DC inlet 56, the storage part 51 and the storage control part 55. The DC inlet 56 is provided to be detachably connected to the rapid charging connector 66 of the rapid charging device 60, which supplies DC power. The storage part 51 is chargeable with the DC power supplied through the DC inlet 56. The storage control part 55 controls the charging and discharging state of the storage part 51.

The charging and discharging device 1 includes the AC inlet 20, the connector 25, the converting part 11 and the charging and discharging control part 15. The AC inlet 20 is capable of being attached to and detached from the connector 78 of the normal charging device 70. The connector 25 is capable of being attached to and detached from the DC inlet 56. The converting part 11 converts the AC power, which is supplied from the normal charging device 70 through the AC inlet 20, into the DC power. The charging and discharging control part 15 controls the power conversion in the converting part 11.

Assuming that the storage part 51 of the power storage device 50 is capable of being charged with the DC power supplied from the rapid charging device 60, transfer of power between the normal charging device 70 and the charging and discharging device 51 is enabled by connecting the power storage device 50 and the normal charging device 70 through the charging and discharging device 1, which is detachable. The storage part 51 of the power storage device 50 is chargeable with the power supplied from the normal charging device 70. Thus the configuration of the power storage device 50 is simplified.

Since the power storage device 50 is mounted on the vehicle 40, the weight of the vehicle 40 can be reduced and limitations to the designing of the vehicle 40 can be reduced. Further, since the DC inlet 56 and the connector 78 are connected through the charging and discharging device 1, a connector part for connecting the power storage device 50 to the rapid charging device 60 or the normal charging device 70 can be simplified to only one DC inlet 56. By carrying the charging and discharging device 1, the power storage device 50 and the normal charging device 70 are enabled to transfer power therebetween. For example, since the storage part 51 can be charged by the normal charging device 70, convenience of the user can be maintained. Further, since the charging and discharging device 1 need not be carried when charging of the normal charging device 70 at the visiting place is not planned, the weight of the vehicle 40 can be reduced.

The charging and discharging control part 15 is capable of communication with the storage control part 55. Thus, the storage part 51 can be charged and discharged as desired by communication of Information between the charging and discharging control part 15 and the storage control part 55. The charging and discharging control part 15 uses the power supplied from the normal charging device 70 as the control power. Thus the configuration of the charging and discharging device 1 can be simplified in comparison to a case, in which a power supply source is provided for supply of the control power. The charging and discharging device 1 includes the switching part 12. The switching part 12 is provided between the converting part 11 and the connector 25 to switch over conduction (ON) and shut-off (OFF) of the current between the converting part 11 and the connector 25. Thus, when the normal charging device 70 and the power storage device 50 are connected through the charging and discharging device 1, power supply between the normal charging device 70 and the power storage device 50 can be suitably started and completed.

### Second Embodiment

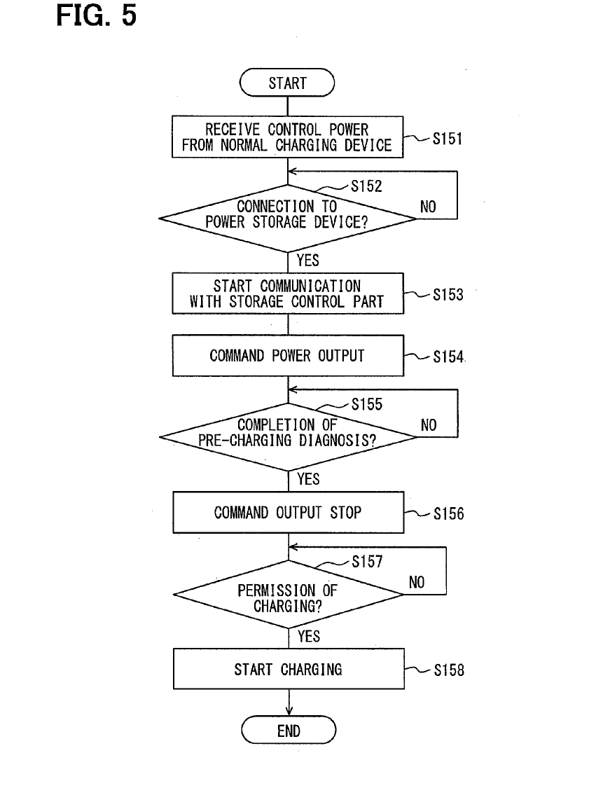

A second embodiment is shown in FIGS. 4 and 5. In FIG. 4, the rapid charging device 60 is not shown for simplification of illustration and description. For the same reason, the rapid charging device 60 is not shown either in FIG. 8, FIG. 10 and FIG. 12, which will be referred to later. As shown in FIG. 4, a charging and discharging device 2 is provided with a diode 13 in the high-potential power line in place of the switching part 12 provided in the first embodiment. The diode 13 permits power supply from the normal charging device 70 side to the power storage device 50 side and prohibits power supply from the power storage device 50 side to the normal charging device 70 side.

A charging starting processing according to the second embodiment will be described with reference to a flowchart shown in FIG. 5. Similarly to the first embodiment described above, the charging starting processing is executed by the charging and discharging control part 15 after the AC inlet 20 of the charging and discharging device 1 and the connector 78 of the normal charging device 70 have been connected and the power supply from the normal charging device 70 to the charging and discharging device 1 has been permitted. Processing of S151 to S153 is the same as the processing of S101 to S103 shown in FIG. 3. Processing of S154 and S155 is the same as the processing of S105 and S106 shown in FIG. 3. After it is determined at S155 that the pre-charging diagnosis has been completed (S155: YES), S156 is executed.

At S156, a command for stopping power output is issued to the converting part 11 so that the power output is stopped. Processing of S157 is the same as the processing of S108 shown in FIG. 3. When it is determined that a signal indicating a permission of charging has been received from the storage control part 55 (S157: YES), S158 is executed. At S158, a command for power output is issued to the converting part 11 so that the storage part 51 is charged with the power supplied from the normal charging device 70.

The charging and discharging device 2 includes the diode 13 provided between the converting part 11 and the connector 25. The diode 13 prevents a current from flowing in reverse from the power storage device 50 side to the normal charging device 70 side. Further, in comparison to the case that the switching part 12 is provided as in the first embodiment described above, configuration of the charging and discharging device 2 and control executed in the charging and discharging control part 15 can be simplified. In addition, the second embodiment also provides the similar advantages as the first embodiment.

### Third Embodiment

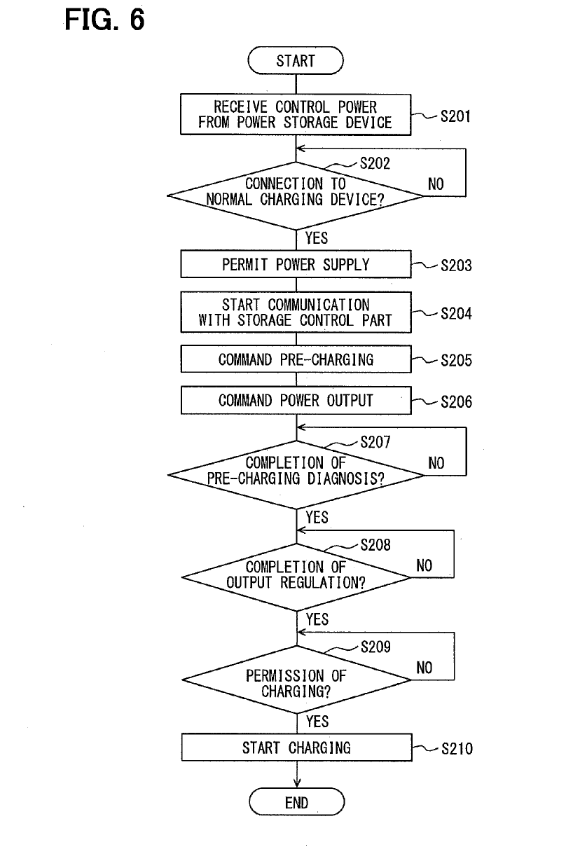

A third embodiment will be described with reference to FIG. 6. In the third embodiment, the configuration of the charging and discharging device is the same as the first embodiment and only the charging starting processing is different from that of the first embodiment. This difference will be described below. In the first embodiment, the control power is received from the normal charging device 70 side. The third embodiment is different from the first embodiment in that the control power is received from the power storage device 50 side.

Charging starting processing according to the third embodiment will be described with reference to a flowchart shown in FIG. 6. The charging starting processing in the third embodiment is executed by the charging and discharging control part 15 after the connector 25 of the charging and discharging device 1 and the DC inlet 56 of the power storage device 50 is been connected and a power supply starting operation is performed by the user. At S201, the power required for the operation of the charging and discharging device 1 is received from the power storage device 50 and used as the control power.

At S202, it is checked whether the AC inlet 20 of the charging and discharging device 1 and the connector 78 of the normal charging device 70 have been connected and connection to the normal charging device 70 has been detected. When it is determined that the connection to the normal charging device 70 has not yet been detected (S202: NO), this checking step S202 is repeated. When it is determined that the connection to the normal charging device 70 has been detected (S202: YES), S203 is executed. At S203, power supply from the normal charging device 70 is permitted. Processing of S204 to S210 is the same as the processing of S103 to S109 shown in FIG. 3.

According to the third embodiment, the charging and discharging control part 15 uses the power supplied from the power storage device 50 as the control power. Thus the configuration of the charging and discharging device 1 can be simplified in comparison to a case, in which a power supply part for control power is provided separately. The third embodiment also provides the similar advantages as the embodiments described above.

### Fourth Embodiment

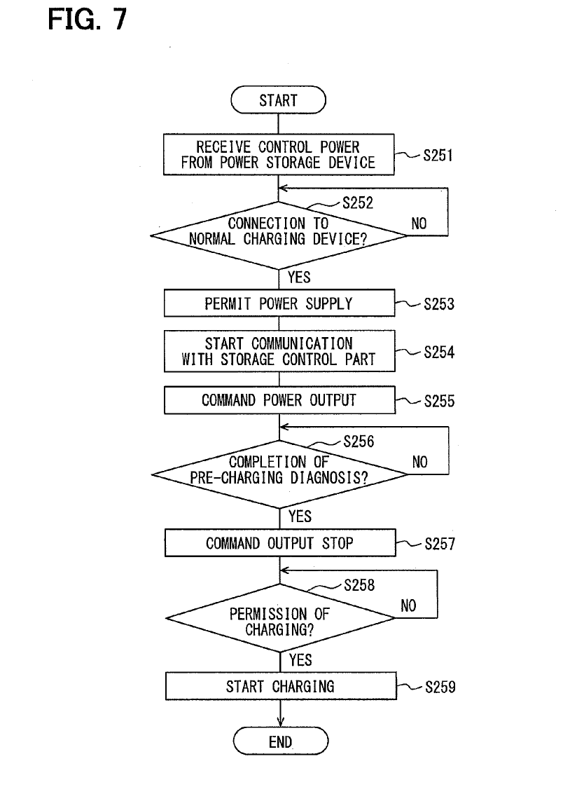

A fourth embodiment will be described with reference to FIG. 7. In the fourth embodiment, the configuration of the charging and discharging device is the same as the second embodiment and only the charging starting processing is different from the second embodiment. This difference will be described below. In the second embodiment, the control power is received from the normal charging device 70 side. Similarly to the third embodiment, the fourth embodiment is different from the second embodiment in that the control power for the charging and discharging device 2 is received from the power storage device 50 side.

Charging starting processing according to the fourth embodiment will be described with reference to a flowchart shown in FIG. 7. The charging starting processing in the fourth embodiment is executed by the charging and discharging control part 15 after the connector 25 of the charging and discharging device 1 and the DC inlet 56 of the power storage device 50 have been connected and the power supply starting operation has been performed by the user. Processing of S251 to S253 is the same as the processing of S201 to S203 shown in FIG. 6. Processing of S254 to S259 is the same as the processing of S153 and S158 shown in FIG. 5. The fourth embodiment also provides the similar advantages as the embodiments described above.

### Fifth Embodiment

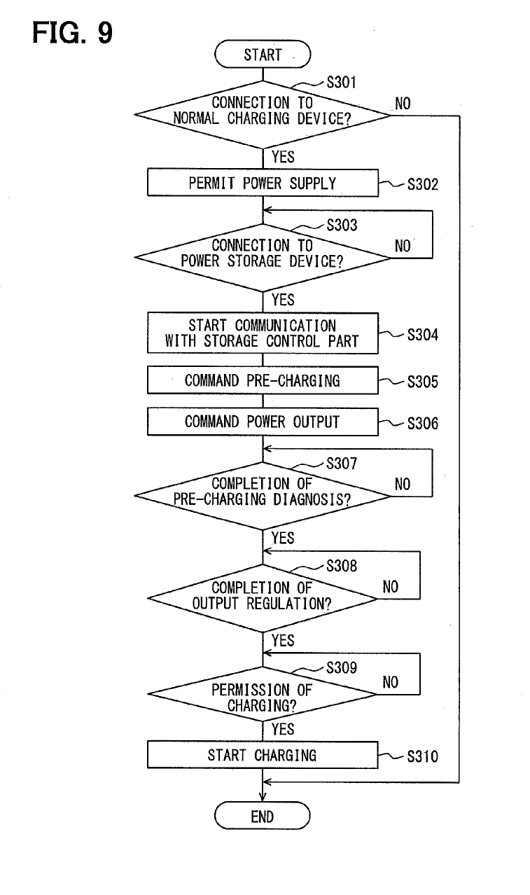

A charging and discharging device according to a fifth embodiment will be described with reference to FIG. 8 and FIG. 9. As shown in FIG. 8, a charging and discharging device 3 according to the fifth embodiment includes a power supply part 17 for supplying power required for the charging and discharging device 3. That is, the charging and discharging device 3 is provided with the control power supply source internally. The charging and discharging device 3 has the same configuration as the charging and discharging device 1 of the first embodiment except for the power supply part 17. In FIG. 8, a solid-line arrow indicates a power supply path from the power supply part 17. The same indication applies to FIG. 10.

Charging starting processing in the fifth embodiment will be described with reference to a flowchart shown in FIG. 9. Charging and discharging control processing in the fifth embodiment is executed by the charging and discharging control part 15 at a predetermined interval. At S301, it is checked first whether the AC inlet 20 of the charging and discharging device 3 and the connector 78 of the normal charging device 70 ha been connected and the connection to the normal charging device 70 has been detected. When it is determined that the connection to the normal charging device 70 has not been detected (S301: NO), processing of S302 and subsequent steps is not executed. When it is determined that the connection to the normal charging device 70 has been detected (S301: YES), S302 is executed. The processing of S302 is the same as the processing of S203 shown in FIG. 6. The processing of S303 to S310 is the same as the processing of S102 to S109 shown in FIG. 3.

The charging and discharging device 3 further includes the power supply part 17, which is capable of supply power to the charging and discharging control part 15. The charging and discharging device 15 uses the power supplied from the power supply part 17 as the control power. According to the fifth embodiment, since the power supply part 17 for supplying the control power is provided within the charging and discharging device 3, control power need not be received from the power storage device 50 or the normal charging device 70. For this reason, processing for receiving the control power from the power storage device 50 or the normal charging device 70 need not be executed. In addition, various calculation processing can be executed without being connected with the power storage device 50 or the normal charging device 70. The fifth embodiment also provides the similar advantages as the embodiments described above.

### Sixth Embodiment

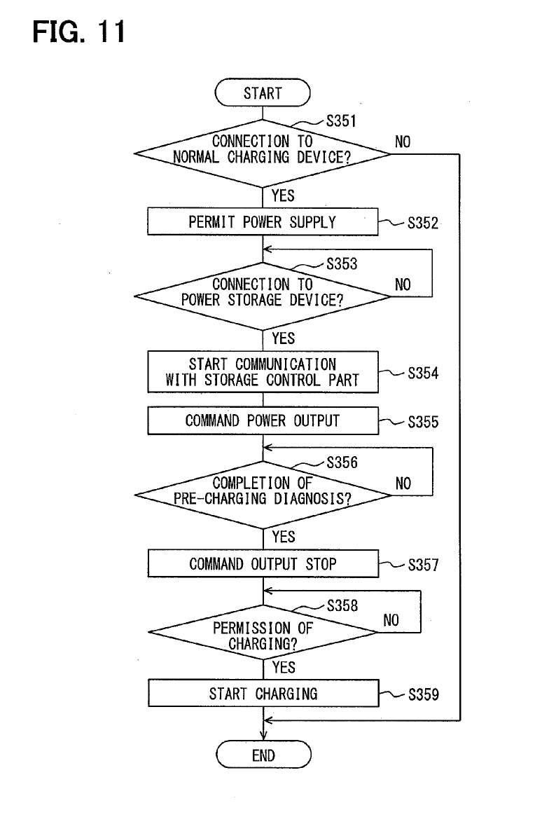

A sixth embodiment will be described with reference to FIG. 6. As shown in FIG. 10, a charging and discharging device 4 includes the power supply part 17 similarly to the charging and discharging device 3 of the fifth embodiment. Further, the charging and discharging device 4 includes the diode 13 similarly to the second embodiment in place of the switching part 12 of the fifth embodiment. Charging and discharging control processing in the sixth embodiment will be described with reference to FIG. 11. The charging and discharging control processing in the sixth embodiment is executed by the charging and discharging control part 15 at a predetermined interval.

Processing of S351 and S352 is the same as the processing of S301 and S302 shown in FIG. 9. Processing of S353 to S359 is the same as the processing of S152 to S158. The sixth embodiment provides the similar advantages as the embodiments described above.

### Seventh Embodiment

A charging and discharging device according to a seventh embodiment will be described with reference to FIG. 12. As shown in FIG. 12, a charging and discharging device 5 according to the seventh embodiment includes an electrical safety part 18 and is configured to be capable of connecting the power storage device 50 and a normal charging device 79. The electrical safety part 18 is a CCID, for example, similarly to the electrical safety part 72 of the normal charging device 70 and includes a shut-off part 19. The electrical safety part 18 detects abnormality like a short-circuit by monitoring the power state. The electrical safety part 18 shuts off power supply from the normal charging device 79 side by shutting off the shut-off part 19, when the abnormality is detected.

The charging and discharging device 5 is similar to the charging and discharging device 1 of the first embodiment except for the electrical safety part 18. In FIG. 12, the charging and discharging device 5 is exemplified as having the switching part 12. However, it may have the diode 13 in place of the switching part 12 as exemplified in the second embodiment and the sixth embodiment. The control power may be supplied from the normal charging device 70 as exemplified in the first embodiment and the second embodiment or from the power storage device 50 as exemplified in the third embodiment and the fourth embodiment. The control power may alternatively be supplied from the power supply part 17, which is additionally provided, as exemplified in the fifth embodiment and the sixth embodiment.

The normal charging device 79 is different from the normal charging device 70 of the embodiments described above in that the electrical safety part 72 is not provided but is the same as the normal charging device 70 in respect to other parts. Thus the configuration of the normal charging device 79 can be simplified. Two electrical safety parts may be provided by connecting the charging and discharging device 5 of the seventh embodiment and the normal charging device 70 of the embodiments described above.

The charging and discharging device 5 includes the electrical safety part 18 having the shut-off part 19, which is capable of shutting off the power supply when abnormality of the power state is detected. Thus, even in the case that the normal charging device 79 is not provided with the electrical safety part, the storage part 51 can be charged appropriately with the power of the normal charging device 79 without using an electrical safety device provided separately. The seventh embodiment also provides the same advantages as the embodiments described above.

### Other Embodiment

(A) Charging and Discharging Device

In the embodiments described above, the charging and discharging device 1 to 5 is exemplified to function as the charging device, which charges the storage part 50 with the power of the normal charging device 70, 79, which is the AC power part. In the other embodiment, the charging and discharging device may be exemplified to function as a discharging device, which supplies the power of the storage part to the AC power part, by setting the AC power part as a load to be driven with AC power and connecting the storage battery device and the AC power part through the charging and discharging device. That is, the charging and discharging device may be used to function as at least one of the charging device for charging the power from the AC power part side to the storage part side and the discharging device for supplying the power from the power storage device side to the AC power part side. When the charging and discharging device is used to function as the charging device, the converting part converts the AC power, which is supplied from the AC power part through the AC connector part, to the DC power. When the charging and discharging device is used to function as the discharging device, the converting part converts the DC power, which is supplied from the storage part through the DC connector part, to the AC power. By using the charging and discharging device to function as the discharging device, the power of the storage part can be supplied externally without adding a separate structural part to the power storage device.

(B) Connection Part

In the embodiments described above, the AC connector part is configured with the AC inlet 20. In the other embodiment, the AC connector part may be configured as the connector, which is provided at the top end of the cable extended from the casing, in a case that the connector part of the AC power part is the inlet, in the similar manner as in a case that the AC power part is for example the commercial power supply source. The AC connector part may be configured in any shape as far as it is detachably connectable to the connector part of the AC power part.

In the embodiments described above, the DC connector part is configured as the DC connector 25. In the other embodiment, the DC connector part may be configured in any shape, which is for example the inlet provided to the casing, as far as it is detachably connectable to the vehicle-side connector part. The AC connector part may be configured to be changeable (detachable) in accordance with the shape of the vehicle-side connector part. The DC connector part may also be changeable.

(C) Switching Part and Diode

In the second embodiment and sixth embodiment, the diodes 13 are provided in place of the switching part 12 of the first embodiment and the fifth embodiment. In the other embodiment, the charging and discharging device may be provided with both of the switching part and the diode.

(D) Power Storage Device

In the embodiments described above, the power storage device 50 is mounted on the vehicle 40. In the other embodiment, the power storage device may be mounted on any bodies other than the vehicle.

(E) AC Power Part

In the embodiments described above, the AC power part is the normal charging device 70, 79. In the other embodiment, the AC power part may be the commercial power supply source. That is, the AC power part need not include the electrical safety device 72, the normal charging switching part 74, the normal charging control part 75 and the like. Further, the AC part may be a load, which is driven with the AC power supplied from the storage part 51 through the charging and discharging device 1 to 5.

The charging and discharging device should not be limited to the embodiments described above but may be implemented in various different embodiments.

What is claimed is:

1. A charging and discharging device capable of connecting an AC power part for supplying or receiving AC power and a power storage device, which includes a storage-side connector part provided to be detachably connectable to a connector part of a DC charging device for supplying DC power, a storage part chargeable with the DC power supplied through the storage-side connector part and a storage control part for controlling a charging and discharging state of the storage part, the charging and discharging device comprising:
an AC connector part detachably connectable to a connector part of the AC power part;
a DC connector part detachably connectable to the storage-side connector part;
a converting part for converting at least one of a conversion of the AC power, which is supplied from the AC power part through the AC connector part, to the DC power and a conversion of the DC power, which is supplied from the storage part through the DC connector part, to the AC power; and
a charging and discharging control part for controlling power conversion in the converting part.

2. The charging and discharging device according to claim 1, wherein:
the charging and discharging control part is capable of communication with the storage control part.

3. The charging and discharging device according to claim 1, wherein:
the charging and discharging control part uses the AC power, which is supplied from the AC power part, as control power.

4. The charging and discharging device according to claim 1, wherein:
the charging and discharging control part uses the DC power, which is supplied from the AC power part, as control power.

5. The charging and discharging device according to claim 1, further comprising:
a power supply part capable of supplying power to the charging and discharging part,
wherein the charging and discharging control part uses power, which is supplied from the power supply part, as control power.

6. The charging and discharging device according to claim 1, further comprising:
an electrical safety part including a switching part, which interrupts power supply when abnormality of power state is detected.

7. The charging and discharging device according to claim 1, further comprising:
a switching part provided between the converting part and the DC connector part to switch over conduction and shut-off of current between the converting part and the DC connector part.

8. The charging and discharging device according to claim 1, further comprising:
a diode provided between the converting part and the DC connector part.
